(19) United States
(12) Patent Application Publication
(10) Pub. No.: US 2025/0233402 A1
(43) Pub. Date: Jul. 17, 2025

(54) ELECTRICAL PROTECTION DEVICE AND ASSOCIATED MONITORING METHOD

(71) Applicant: Schneider Electric Industries SAS, Rueil-Malmaison (FR)

(72) Inventors: Rémy Orban, Saint Martin d'Uriage (FR); Sébastien Heraud, Grenoble (FR)

(73) Assignee: Schneider Electric Industries SAS, Rueil-Malmaison (FR)

(21) Appl. No.: 19/013,717

(22) Filed: Jan. 8, 2025

(30) Foreign Application Priority Data
Jan. 12, 2024 (FR) 2400303

(51) Int. Cl. H02H 3/033; H02H 3/093; H02H 3/44

(52) U.S. Cl. CPC H02H 3/033; H02H 3/0935; H02H 3/44

(57) ABSTRACT

An electrical protection device (10) that includes a mechanical switch (12), a static switch (14), an acquisition module (20) including a current intensity sensor (22) configured so as to measure the intensity of the current and to determine a derivative with respect to time (time derivative) of the current intensity; and an electronic control unit (30), configured so as to determine a first value of an estimated peak current intensity, and to command the switching of the mechanical switch (12) to the open configuration when the first value of the estimated peak current intensity is greater than or equal to a peak current intensity threshold value. The electronic control unit (30) is configured so as to command the switching of the static switch (14) to the isolation configuration when an isolation time period has elapsed; or to determine a second value of the estimated peak current intensity, and command the switching of the static switch (14) to the isolation configuration when the second value of the estimated peak current intensity is greater than or equal to the peak current intensity threshold value.

### FIELD

The present invention relates to an electrical protection device and an associated control method for controlling it.

### BACKGROUND

Electrical protection devices, such as electromechanical circuit breakers or hybrid protection devices incorporating a mechanical switch, a static switch and a voltage-limiting element, are generally controlled to open according to fixed conditions. For example, FR2952470 describes an electrical protection device comprising a static switch and a mechanical contact switch, in which the mechanical contact switch is controlled to open when the electrical current flowing through the device or when a rate of current rise, that is, a derivative with respect to time of the current intensity, exceeds a predetermined fixed threshold value. WO2015028634A1 describes an electrical protection device comprising a bypass switch, a static switch and a galvanic isolation switch. The bypass switch is controlled to open if an instantaneous value of a current flowing through the device, a rate of current rise, or a root-mean-square (RMS) value of the current is greater than a respective predetermined threshold value, or if the sum of the instantaneous value and the rate of current rise is greater than a predetermined threshold value. In addition, opening of the static switch is commanded when a predetermined fixed time period has elapsed, this time period being measured as from the opening of the bypass switch.

However, there are a variety of electrical faults that can lead to the hybrid protection device tripping, which requires the fixed time period between the opening of the bypass switch and the opening of the static switch to be selected either in a manner that ensures the integrity of the protection device, which results in over-dimensioning, or in a manner that optimises the response time, which can give rise to risks of malfunctioning of the device and therefore a risk of failure of the protection device.

### SUMMARY

The aim of the invention is therefore to provide a more reliable electrical protection device that enables effective and safe detection.

To this end, the object of the invention relates to an electrical protection device configured so as to be connected between a source and a load, the device comprising:
a mechanical switch, configured so as to switch between a closed configuration, wherein the mechanical switch conducts a current flowing between the source and the load, and an open configuration, wherein the mechanical switch does not conduct the current;
a static switch, connected in parallel with the mechanical switch, configured so as to switch between a conduction configuration, wherein the static switch conducts the current, and an isolation configuration, wherein the static switch does not conduct the current;
a voltage limiting element, connected in parallel with the static switch and the mechanical switch;
an acquisition module, comprising a current intensity sensor configured so as to measure the intensity of the current, the acquisition module being further configured so as to determine a derivative with respect to time (time derivative) of current intensity; and
an electronic control unit, configured so as to:
   determine a first value of an estimated peak current intensity, as a function of the current intensity and the time derivative of current intensity;
   command the switching of the mechanical switch to the open configuration when the first value of the estimated peak current intensity is greater than or equal to a peak current intensity threshold value.

According to the invention, with the mechanical switch being in the open configuration, the electronic control unit is further configured so as to:
command the switching of the static switch to the isolation configuration when an isolation time period has elapsed; or
determine a second value of the estimated peak current intensity as a function of the current intensity and the time derivative of current intensity, and command the switching of the static switch to the isolation configuration when the second value of the estimated peak current intensity is greater than or equal to the peak current intensity threshold.

Thanks to the invention, it is possible to interrupt the current in the event of a short-circuit in an efficient and safe manner. In fact, the switching of the static switch to the isolation configuration is effectuated as a function of the current intensity and the derivative with respect to time (time derivative) of current intensity, and not after a fixed period of time has elapsed. It is therefore possible to adjust the time period between switching of the mechanical switch to the open configuration and switching of the static switch to the isolation configuration depending on the type of fault. This makes it possible to reduce the time between switching of the mechanical switch to the open configuration and switching of the static switch to the isolation configuration to a minimum without risking, on the one hand, the reappearance of an electric arc between the contacts of the mechanical switch—i.e. dielectric breakdown between the contacts of the mechanical switch, caused by switching of the static switch to the isolation configuration rather prematurely—nor, on the other hand, damage to the static switch, caused by switching of the static switch to the isolation configuration rather tardily.

According to other advantageous aspects of the invention, the device comprises one or more of the following characteristic features, taken into consideration individually or according to any technically feasible combination:
The electronic control unit is configured so as to command, in addition, the switching of the mechanical switch to the open configuration when the current intensity is greater than a current intensity limit.
The electronic control unit is further configured so as to:
   determine a transfer current intensity; and
   determine the isolation time period as a function of the transfer current intensity.
The transfer current intensity is calculated as a function of the current intensity and the time derivative of current intensity.
The transfer current intensity is determined by means of measuring of the current intensity by the acquisition module.
The isolation time period is determined as a function of the transfer current intensity by means of a piecewise constant function.
The isolation time period is determined as a function of the transfer current intensity by means of an affine function.
The acquisition module comprises a sensor for the time derivative of current intensity, configured so as to measure the time derivative of current intensity.
The peak current intensity threshold is lower than 10,000 A.
The peak current intensity threshold is lower than 6,000 A.
The peak current intensity threshold is equal to 4,500 A.

The invention also relates to a control method comprising at least the following steps:
measuring of the current intensity by the acquisition module;
determining of the time derivative of current intensity by the acquisition module;
determining of the first value of the estimated peak current intensity, as a function of the current intensity and of the time derivative of current intensity, by the control unit;
if the first value of the estimated peak current intensity is greater than or equal to the peak current intensity threshold value, commanding, by the electronic control unit, of the switching of the mechanical switch to the open configuration;
determining of the isolation time period or determining of the second value of the estimated peak current intensity; and
if the isolation time period has elapsed, or if the second value of the estimated peak current intensity is greater than or equal to the peak current intensity threshold value, commanding, by the electronic control unit, of the switching of the static switch to the isolation configuration.

Advantageously, the second value of the estimated peak current intensity is determined as a function of a sampling time, and, if the second value of the estimated peak current intensity is strictly lower than the peak current intensity threshold value, the determining of the second value of the estimated peak current intensity is performed again when the sampling time has elapsed.

### BRIEF DESCRIPTION OF THE DRAWINGS

The invention will become more clearly apparent from the description that follows, provided solely by way of non-limiting example, and drawn up with reference to the drawings in which:

FIG. 1 is a diagram of an electrical circuit comprising an electrical protection device in accordance with the invention;

FIG. 2 is a graphical representation of a current flowing through an electrical protection device in accordance with the invention;

FIG. 3 is a graphical representation of the conditions for detecting a short-circuit in an electrical protection device in accordance with the invention;

FIG. 4 is a graphical representation of an isolation time period of an electrical protection device in accordance with the invention, as a function of a transfer current intensity;

FIG. 5 is a flow chart of a first control method in accordance with the invention and implemented by the device according to the invention; and

FIG. 6 is a flow chart of a second control method in accordance with the invention and implemented by the device according to the invention.

### DETAILED DESCRIPTION

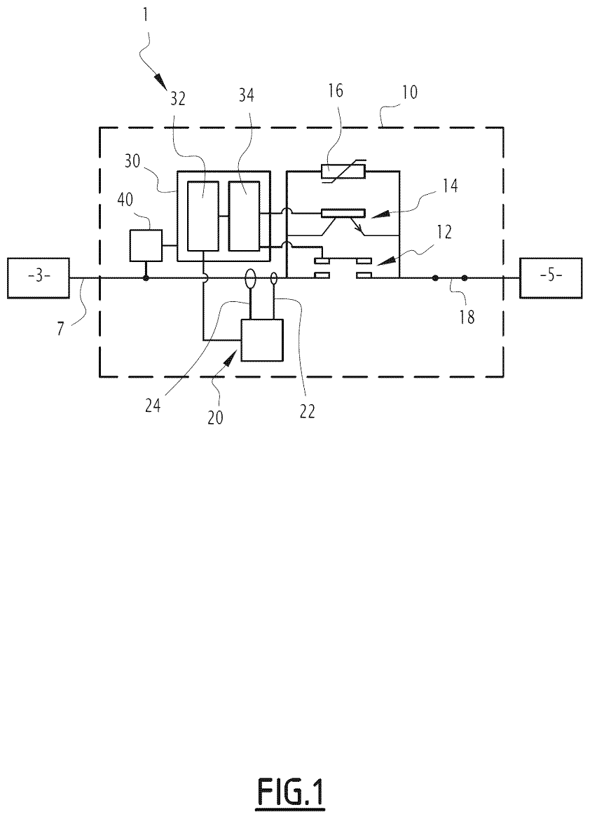

FIG. 1 is a diagram of an electrical circuit 1 comprising a source 3 and a load 5, electrically connected to each other by a phase conductor 7. The source 3 supplies electricity and is, for example, an electrical generator or a power grid, for example a mains power grid. The load 5 is an appliance that consumes electricity, such as a domestic electrical appliance; industrial equipment such as an electric motor; or a server. Thus, an electric current, hereinafter referred to simply as current, flows between the source 3 and the load 5 through the phase conductor 7.

The current is an alternating current, for example single-phase or multi-phase; or a direct current.

The electrical circuit 1 also comprises an electrical protection device 10, also referred to as a device, that is connected between the source 3 and the load 5. The device 10 is configured so as to switch between an armed configuration, wherein the device 10 conducts the current flowing between the source 3 and the load 5, and a tripped configuration, wherein the device 10 electrically isolates the source 3 from the load 5.

The device 10 comprises a mechanical switch 12, a static switch 14 and a voltage limiting element 16.

The mechanical switch 12 is also referred to as a bypass switch or also a FMS (Fast Mechanical Switch). The mechanical switch 12 is connected in series between the source 3 and the load 5 and is configured so as to switch between a closed configuration, wherein it conducts the current flowing between the source 3 and the load 5, and an open configuration, wherein it does not conduct the current. In FIG. 1, the mechanical switch 12 is represented in the open configuration.

The static switch 14 comprises at least one switch-controllable semiconductor element, for example at least one transistor, such as a Field Effect Transistor (or FET), a Metal Oxide Semiconductor Field Effect Transistor (or MOSFET), a bipolar transistor, or a combination of these different semiconductor elements. The static switch 14 is connected in parallel with the mechanical switch 12. The static switch 14 is configured so as to switch between a conduction configuration, wherein the static switch 14 conducts the current flowing between the source 3 and the load 5, and an isolation configuration, wherein it does not conduct the current.

The voltage limiting element 16 is, for example, a varistor and is connected in parallel with the mechanical switch 12 and the static switch 14. When the mechanical switch 12 is in the open configuration and the static switch 14 is in the isolation configuration, the voltage limiting element 16 is configured so as to dissipate the energy contained in the circuit 1, in other words to cut off the electrical current.

The device also comprises a disconnecting switch 18, connected between the source 3 and the load 5, in series with the mechanical switch 12. The static switch 14 is not connected in parallel with the disconnecting switch 18. In FIG. 1, the disconnecting switch 18 is connected downstream of the mechanical switch 12, i.e. between the mechanical switch 12 and the load. By way of a variant not represented, the disconnecting switch 18 is connected upstream of the mechanical switch 12, i.e. between the source 3 and the mechanical switch 12.

The disconnecting switch 18 is configured so as to switch between a closed configuration wherein the disconnecting switch 18 conducts the current and an open configuration wherein the disconnecting switch 18 does not conduct the current. The disconnecting switch 18 is configured so as to switch to the open configuration when current is interrupted between the source 3 and the load 5, in other words when no current is flowing between the source 3 and the load 5 in the phase conductor 7.

The device 10 also comprises an acquisition module 20. The acquisition module 20 comprises a current intensity sensor 22, configured so as to measure the intensity I of the current flowing through the device 10. The current intensity I is an instantaneous current intensity, as opposed to an effective or average current intensity, and corresponds to the sum of the intensities 112, 114 and 116 of the currents flowing respectively through the mechanical switch 12, the static switch 14, and the voltage limiting element 16. Advantageously, the current intensity I is measured continuously.

Advantageously, the device 10 comprises a sensor 24 for the time derivative I′ of the current intensity 1, also known as the current intensity derivative sensor 24. Advantageously, the current intensity derivative sensor 24 is a toroid or a Rogowski coil and is configured so as to measure the time derivative I′ of the current intensity 1, hereinafter referred to as the derivative I′. Advantageously, the derivative I′ is measured continuously.

By way of a variant not represented, the acquisition module 20 comprises a derivation sub-module, configured so as to determine the derivative I′ on the basis of the current intensity I as measured by the current intensity sensor 22.

The device 10 further comprises an electronic control unit 30, connected to the acquisition module 20 and to the mechanical 12 and static 14 switches.

Advantageously, the electronic control unit 30 comprises a determination module 32, connected to the acquisition module 20, and a control module 34, connected to the determination module 32 and to the static switch 14. In the example shown in FIG. 1, the determination module 32 and the control module 34 are each implemented in the form of a software programme, which is executable by a processor not represented, and included in the electronic control unit 30. By way of a variant not represented, the determination module 32 and the control module 34 are each implemented in the form of a programmable logic component, such as an FPGA (Field Programmable Gate Array), an integrated circuit, such as an ASIC (Application Specific Integrated Circuit), or a microcontroller.

The device 10 also comprises a power supply unit 40, connected to the phase conductor 7 and to the electronic unit 30. The power supply unit 40 is configured so as to supply electrical power to the electronic unit 30 from the current flowing in the phase conductor 7. By way of a variant, the power supply unit 40 is connected to a separate electrical circuit, which is not connected to the phase conductor 7.

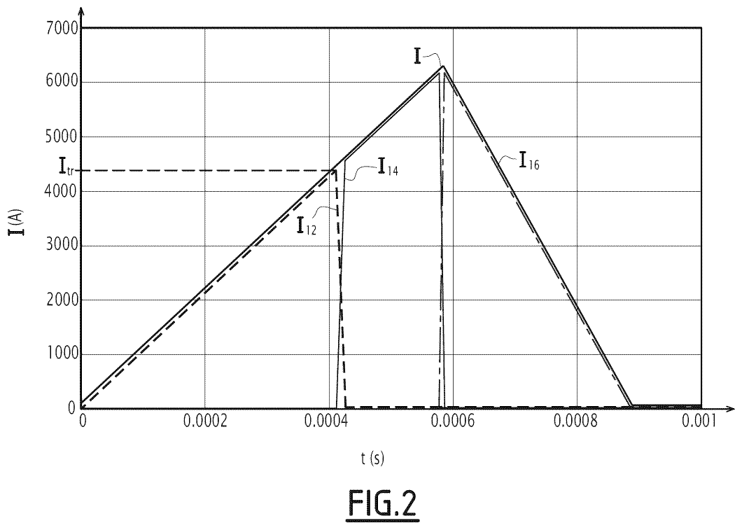

FIG. 2 is a graphical representation of the evolution of the current intensity I in the device 10 during a short-circuit. Before the short-circuit, the mechanical switch 12 is in the closed configuration and the static switch 14 is in the conduction or isolation configuration. The current flows through the mechanical switch 12.

Upon the short-circuit occurring, the current intensity I increases and therefore the intensity 112 of the current flowing through the mechanical switch 12 increases until it reaches a maximum, referred to as the transfer current intensity Iₜᵣ. When the mechanical switch 12 switches to the open configuration, the current is diverted from the mechanical switch to the static switch 14: the current intensity 112 decreases from the transfer current intensity Iₜᵣ until it becomes zero and the current intensity 114 flowing through the static switch increases until it becomes equal to the current intensity 1, which continues to increase. Finally, when the static switch 14 is commanded to pass into the isolation configuration, with the mechanical switch 12 remaining in the open configuration, the current is diverted to the voltage-limiting element 16: the intensity 116 of the current flowing through the voltage-limiting element 16 increases until it becomes equal to I, which thereafter decreases until it becomes zero due to the presence of the voltage-limiting element 16.

During a short-circuit, a value of the current intensity just before the device 10 switches to the tripped configuration is referred to as the peak current intensity. In order to prevent damage to the device 10, the peak current intensity must not exceed a maximum peak current intensity value Iₚₘₐₓ, for example equal to 10,000 A. Measuring of the current intensity I and the derivative I′ enables the determination module 32 to determine a first estimated peak current intensity value Iₚ₁, according to the formula:

$${I}_{p 1} = I + {I}^{′} \times {T}_{d}$$

T_{d} is an estimated total tripping time; this is an estimate of a time period elapsing between a time instant at which the control module 34 sends a switching command to switch the mechanical switch 12 to the open configuration and a time instant at which the device 10 actually switches to the tripped configuration, in other words the time instant at which the static switch 14 actually switches to the isolation position. The estimated total tripping time T_{d} is, for example, programmed in advance by means of the design and construction of the device 10. It may, for example, be set to be less than or equal to 100 μs.

If the first estimated peak current intensity value Iₚ₁ is greater than a peak current intensity threshold value Iₜₕ, then the control module 34 commands passing of the mechanical switch 12 into the open configuration. The peak current intensity threshold value Iₜₕ is selected, for example, to be equal to 80% of the maximum peak current intensity value Iₚₘₐₓ. The peak current intensity threshold value Iₜₕ is, for example, less than 10,000 A, preferably less than 6,000 A, more preferably less than 5,000 A, and even more preferably equal to 4,500 A. The total tripping time of the device, between detection of the short-circuit and switching of the static switch 14 to the isolation configuration, is advantageously less than 1 ms, advantageously of the order of a few hundred microseconds, for example equal to 800 μs.

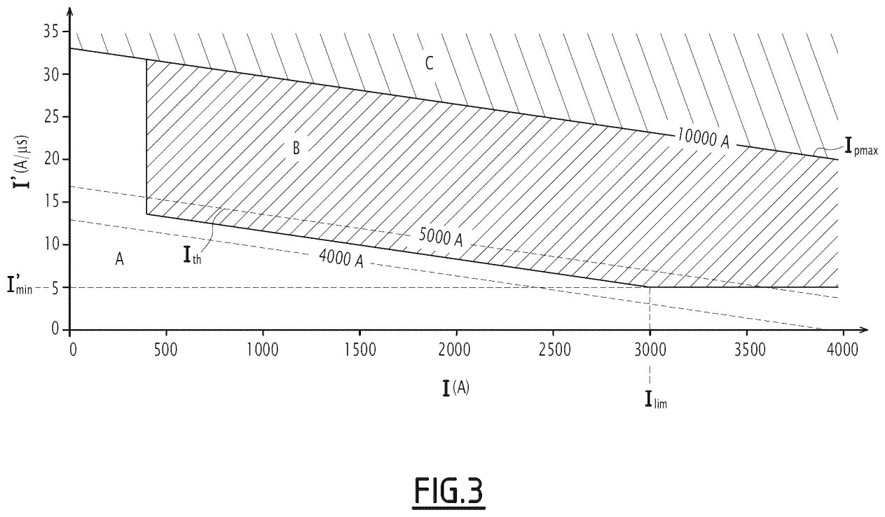

FIG. 3 is a graphical representation of the derivative I′ as a function of the current intensity I. The peak current intensity threshold value Iₜₕ is represented based on an example, as well as the different operating zones A, B and C of the device 10. In the example shown in FIG. 3, the peak current intensity threshold value Iₜₕ is 4500 A for a current intensity I of between 400 and 3000 A and depends only on the derivative I′ if the current intensity I is greater than 3000 A. If the current intensity I is lower than 400 A, whatever be the value of the derivative I′, and therefore whatever be the first value of the peak current intensity _{Ip1}, the mechanical switch 12 remains in the closed configuration. Where the current intensity I is between 250 and 3000 A, the control module 34 commands passing of the mechanical switch 12 into the open configuration if the first estimated peak current value _{Ip1} is greater than 4500 A. Where the current intensity I is greater than or equal to 3000 A, then the control module 34 commands passing of the mechanical switch 12 into the open configuration only if the value of the derivative I′ is greater than a minimum derivative value I′ₘᵢₙ, whatever be the first value of the peak current intensity _{Ip1}. This current intensity of 3000 A, beyond which the control of the mechanical switch 12 depends only on the derivative I′, is referred to as the threshold current intensity Iₗᵢₘ. Generally speaking, if the current intensity I is greater than or equal to the threshold current intensity Iₗᵢₘ, then the control module 34 commands passing of the mechanical switch 12 into the open configuration only if the value of the derivative I′ of the current intensity I is greater than the minimum derivative value I′ₘᵢₙ. In particular, the minimum derivative value I′ₘᵢₙ is selected so as to be relatively low, for example of the order of a few Amperes per microsecond, in this case 5 A/μs.

Thus, zone A in FIG. 3 corresponds to: the values of current intensity I and derivative I′ such that the first estimated peak current intensity value Iₚ₁ is lower than the peak current intensity threshold value Iₜₕ; and therefore, to an operating zone of the mechanical switch 12 in the closed configuration. Zone B corresponds to: the values of current intensity I and derivative I′ such that the first estimated peak current intensity value Iₚ₁ is between Iₜₕ and Iₚₘₐₓ and the derivative I′ is greater than the minimum derivative value I′ₘᵢₙ; and therefore to a zone in which the control module 34 commands passing of the mechanical switch 12 into the open configuration. Zone C corresponds to a forbidden zone, in which the current intensity values I passing through the device 10 would damage the device 10.

Using the first estimated current intensity value Iₚ₁ serves to prevent tripping of the device 10 based solely on the derivative I′, which is subject to sudden fluctuations without these being necessarily caused by a short-circuit, but which may be caused by current harmonics, electromagnetic disturbances or a lightning wave. In fact, as long as the first estimated peak current intensity value Iₚ₁ is lower than the peak current intensity threshold value Iₜₕ, the mechanical switch 12 remains in the closed configuration, thus allowing for the possibility of transient faults—which therefore have little impact on the current intensity value I—to disappear without tripping the device 10.

Thus, using the first estimated current intensity value Iₚ₁ makes it possible to distinguish short-circuits from transient fluctuations that are due, for example, to the starting up of the load 5, thereby enabling time to be saved as compared to tripping based solely on the current intensity 1, since it is not necessary to wait until the current intensity I exceeds the peak current intensity threshold Iₜₕ for the mechanical switch 12 to switch to the open configuration.

In order to command the switching of the static switch 14 to the isolation configuration and thus cut off the current in the circuit 1, without stressing or damaging the device, it is necessary to adapt to the conditions of the short-circuit and therefore to the values of the current intensity I and the derivative I′.

In order to interrupt the current safely, it is necessary to ensure that, during switching of the static switch 14 to the isolation configuration, the mechanical switch 12, which is in the open configuration, remains electrically isolating, in other words, does not snap back. To achieve this, it is necessary to wait for a minimum time period during which the dielectric strength of the mechanical switch 12 is restored, from the time instant at which the mechanical switch 12 switches to the open configuration. This minimum time for restoring the dielectric strength of the mechanical switch 12 depends in particular on the transfer current intensity I_{tr:}: the higher the transfer current intensity Iₜᵣ, the longer the minimum time period for restoring the dielectric strength of the mechanical switch 12.

According to one embodiment, the determination module 32 is configured so as to determine the transfer current intensity Iₜᵣ and to infer therefrom when to command passing of the static switch 14 into the open configuration.

According to one example, the transfer current intensity Iₜᵣ is obtained directly based on the measurement of the current intensity I by the current sensor 22, the transfer current intensity Iₜᵣ then being equal to the current intensity I at the time of switching of the mechanical switch 12 to the open position.

The switching of the mechanical switch 12 is for example measured directly by means of a voltage sensor, not represented, a voltage at the terminals of the mechanical switch 12 increasing when the mechanical switch 12 switches to the open configuration.

By way of variant, the switching of the mechanical switch 12 to the open configuration is estimated as from the time instant at which the control module 34 sends the switching command for switching the mechanical switch 12 to the open configuration. In particular, a time period between the sending of the switching command and the switching of the mechanical switch 12 is known in advance and is, for example, of the order of 50 μs.

By way of variant, the transfer current intensity Iₜᵣ is calculated based on the current intensity I and the derivative I′ as measured when a short-circuit is detected, such that:

$${I}_{tr} = I + {I}^{′} \times {T}_{b a s c}$$

where T_{basc} is a time period between the sending of the switching command and the switching of the mechanical switch 12.

The determination module 32 is configured so as to allow the elapsing of an isolation time period Tᵢₛ, it elapsing from the switching of the mechanical switch 12 to the open configuration, with the isolation time period Tᵢₛ being determined as a function of the transfer current intensity Iₜᵣ. When the isolation time period Tᵢₛ has elapsed, the control module 34 commands actuation of the static switch 14 in order for it to switch to the isolation configuration.

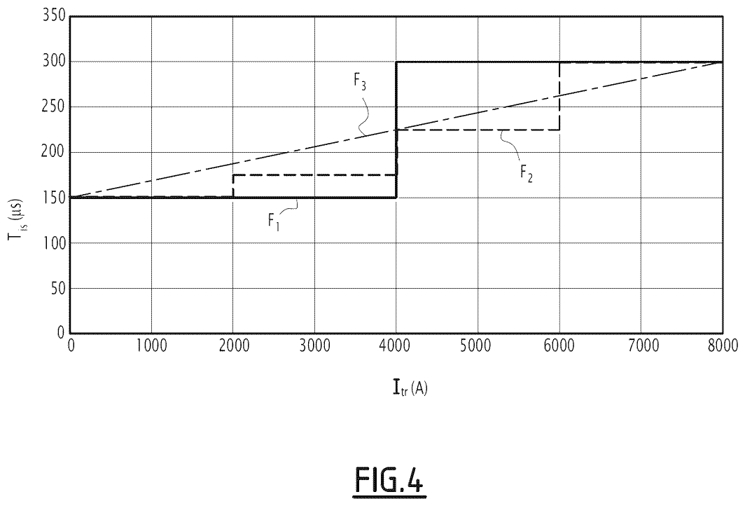

The isolation time period Tᵢₛ is greater than or equal to the minimum time required to restore the dielectric strength of the mechanical switch 12. Examples of functions based on which the isolation time period Tᵢₛ is determined are shown in FIG. 4. For example, the isolation time period Tᵢₛ is determined on the basis of the transfer current intensity Iₜᵣ based on a function F₁, which is a piecewise constant function with a discontinuity at 4000 A; based on a function F₂, which is a piecewise constant function with a first discontinuity at 2000 A, a second discontinuity at 4000 A, and a third discontinuity at 6000 A; or based on a function F₃, which is an affine function.

In the case where the isolation time period Tᵢₛ is determined based on the function F₁, if the transfer current intensity Iₜᵣ is less than 4000 A, then the isolation time period Tᵢₛ is equal to 150 μs, and otherwise, the isolation time period Tᵢₛ is equal to 300 μs.

In a particularly advantageous manner, the isolation time period Tᵢₛ takes into account any possible delay between the sending of the command by the control module 34 and the switching of the static switch 14 to the isolation position.

According to one alternative embodiment, the determination module 32 is configured so as to determine a second value of the estimated peak current intensity Iₚ₂, as a function of the current intensity I and of the derivative I′ once the mechanical switch 12 is in the open configuration. Advantageously, the determination module 32 determines the second value of the estimated peak current intensity Iₚ₂ once the mechanical switch 12 is in the open configuration and when a safety time period, equal to or possibly greater than the minimum time period for restoring the dielectric strength of the mechanical switch 12, has elapsed.

The second value of the estimated peak current intensity Iₚ₂ is estimated from the current intensity I and the derivative I′ as measured by the acquisition module 20 once the mechanical switch 12 is in the open configuration, according to the following formula:

$${I}_{p 2} = I + {I}^{′} \times {T}_{e c h}$$

where T_{ech} is a predetermined sampling time.

If the second value of the estimated peak current intensity Iₚ₂ is greater than or equal to the peak current intensity threshold value Iₜₕ, the control module 24 commands the switching of the static switch 14 to the isolation configuration.

If the second value of the estimated peak current intensity Iₚ₂ is less than the peak current intensity threshold value Iₜₕ, the static switch 14 does not switch to the isolation configuration. The control module 30 waits for the sampling time T_{ech} to elapse, after which it recalculates the second value of the estimated peak current intensity Iₚ₂ using the new values of the current intensity I and the derivative I′.

Advantageously, the determination module 32 determines whether or not a maximum time period Tₘₐₓ has elapsed since the switching of the mechanical switch 12, and the control module 34 commands the switching of the static switch 14 to the isolation configuration if the maximum time period Tₘₐₓ has elapsed. This serves to prevent the static switch 14 from conducting current for excessively long periods, which could wear out or damage it, and to ensure that the current is indeed interrupted once the mechanical switch 12 is in the open configuration.

Once the current has been interrupted, in an advantageous manner, the electronic control unit 30, for example via the control module 34, commands the switching of the disconnecting switch 18 to the open configuration, in order to achieve galvanic isolation between the source 3 and the load 5.

As long as the second value of the estimated peak current intensity Iₚ₂ is less than the peak current intensity threshold value Iₜₕ and the maximum time period Tₘₐₓ has not elapsed, the static switch 14, and the device 10 in general, will be able to withstand the current without risking damage. Waiting until the second value of the estimated peak current intensity Iₚ₂ exceeds the peak current intensity threshold value Iₜₕ serves to increase the time during which the dielectric strength of the switch 12 is restored and therefore to increase the reliability of the device 10, without however the device 10 being at risk of being damaged. The device 10 thus makes it possible to adapt to the type of short-circuit occurring: a short-circuit with a very rapid increase in current intensity will be interrupted rapidly, thereby favouring a rapid response from the device 10, while a short-circuit with a slower increase in current intensity will be interrupted more slowly, thereby favouring the availability of the device 10. This also makes it possible to limit errors in predicting the values of the estimated peak current intensities Iₚ₁ and Iₚ₂ or the transfer current intensity Iₜᵣ, which could be caused by unforeseen fluctuations in the current.

By way of a variant not depicted, the current flowing between the source 3 and the load 5 is multiphase. In this case, advantageously, the protection device 10 comprises a plurality of assemblies, each comprising a mechanical switch 12, a static switch 14, and a voltage limiting element 16 connected in parallel with one another, with each assembly being connected between the source 3 and the load 5 on one phase.

By way of a variant not depicted, the source 3 and the load 5 are connected by one, or possibly a plurality of phase conductors, and one neutral conductor. In this case, in an advantageous manner, the device 10 also comprises a disconnecting switch, connected in series to the neutral conductor.

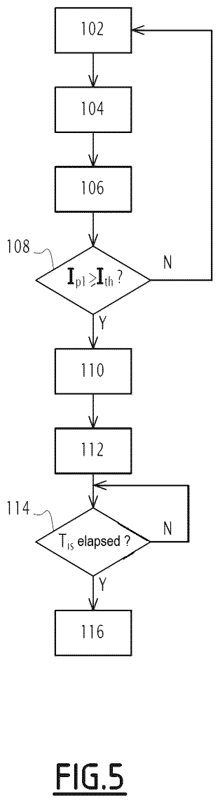

A control method for controlling the device 10 according to a first embodiment is described below, with reference to FIG. 5.

A measurement step 102 for measuring the current intensity I is performed by the current sensor 22.

A measurement step 104 for measuring the derivative I′ is performed by the current intensity derivative sensor 24. By way of a variant, step 104 is a determination step for determining of the derivative I′ by the acquisition module 20, on the basis of the current intensity I.

A determination step 106 for determining the first value of the estimated peak current intensity Iₚ₁ is performed by the determination module 32.

Following step 106, a comparison step 108 for comparing the first value of the estimated peak current intensity Iₚ₁ and the peak current intensity threshold value Iₜₕ is performed by the determination module 32.

If the first value of the estimated peak current intensity Iₚ₁ is less than the peak current intensity threshold value Iₜₕ, the device 10 performs steps 102 to 106 again.

If the first value of the estimated peak current intensity Iₚ₁ is greater than or equal to the peak current intensity threshold value Iₜₕ, the control module 34 commands the switching of the mechanical switch 12 to the open configuration at step 110.

Once step 110 has been performed, a determination step 112 for determining the isolation time period Tᵢₛ is performed by the determination module 32, the isolation time period Tᵢₛ being obtained as described above.

A monitoring step 114 is performed by the determination module 32, in order to determine whether the isolation time period Tᵢₛ has elapsed.

Step 114 is repeated as long as the isolation time period Tᵢₛ has not elapsed.

When the isolation time period Tᵢₛ has elapsed, the control module 34 commands the opening of the static switch 14 in step 116.

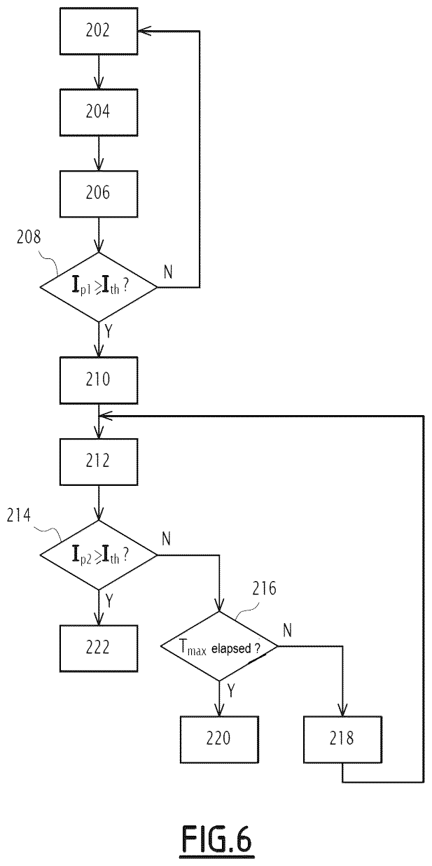

A control method for controlling the device 10 according to an alternative embodiment is described below, with reference to FIG. 6.

Steps 202 to 210 are respectively identical to steps 102 to 110 of the method shown in FIG. 5 and are thus not described again.

Advantageously, upon step 210 having been carried out and the safety time having elapsed, a determination step 212 for determining the second value of the estimated peak current intensity Iₚ₂ is performed by the determination module 32.

A comparison step 214 for comparing the second value of the estimated peak current intensity Iₚ₂ and the peak current intensity threshold value Iₜₕ is performed by the determination module 32.

If the second value of the estimated peak current intensity Iₚ₂ is less than the peak current intensity threshold value Iₜₕ, a verification step 216 for verifying that the maximum time period Tₘₐₓ has elapsed is performed by the determination module 32.

If the maximum time period Tₘₐₓ has not elapsed, the computation module 12 waits through the sampling time T_{ech} during a step 218, and then performs step 212 again.

If the maximum time period Tₘₐₓ has elapsed, the control module 34 commands the switching of the static switch 14 to the isolation configuration during a step 220.

If the second value of the estimated peak current intensity _{Ip2} is greater than or equal to the peak current intensity threshold value Iₜₕ, a control-command step 222 for actuating the static switch 14 to the isolation configuration is performed by the control module 34.

In an advantageous manner, during a control step for controlling the disconnecting switch 18, not shown, the electronic control unit 30, for example via the control module 34, commands the switching of the disconnecting switch 18 to the open configuration, in order to isolate the source 3 from the load 5.

Any characteristic feature described for one embodiment or variant in the foregoing may be implemented for the other embodiments and variants previously described above, insofar as they are technically feasible.

1. An electrical protection device, configured so as to be connected between a source and a load, the device comprising:
a mechanical switch, configured so as to switch between a closed configuration, wherein the mechanical switch conducts a current flowing between the source and the load, and an open configuration, wherein the mechanical switch does not conduct the current;
a static switch, connected in parallel with the mechanical switch, configured so as to switch between a conduction configuration, wherein the static switch conducts the current, and an isolation configuration, wherein the static switch does not conduct the current;
a voltage limiting element, connected in parallel with the static switch and the mechanical switch;
an acquisition module, comprising a current intensity sensor configured so as to measure the intensity of the current, the acquisition module being further configured so as to determine a derivative with respect to time of the current intensity; and
an electronic control unit, configured so as to:
determine a first value of an estimated peak current intensity, as a function of the current intensity and the time derivative of current intensity;
command a switching of the mechanical switch to the open configuration when the first value of the estimated peak current intensity is greater than or equal to a peak current intensity threshold value;
wherein, with the mechanical switch being in the open configuration, the electronic control unit is further configured so as to:
command the switching of the static switch to the isolation configuration when an isolation time period has elapsed; or
determine a second value of the estimated peak current intensity as a function of the current intensity and the time derivative of current intensity, and command the switching of the static switch to the isolation configuration when the second value of the estimated peak current intensity is greater than or equal to the peak current intensity threshold value.

2. A device according to claim 1, wherein the electronic control unit is configured so as to command, in addition, the switching of the mechanical switch to the open configuration when the current is greater than a current intensity limit.

3. A device according to claim 1, wherein the electronic control unit is further configured so as to:
determine a transfer current intensity; and
determine the isolation time period, as a function of the transfer current intensity.

4. A device according to claim 3, wherein the transfer current intensity is calculated as a function of the current intensity and the time derivative of the current intensity.

5. A device according to claim 3, wherein the transfer current intensity is determined by means of measuring of the current intensity by the acquisition module.

6. A device according to claim 3, wherein the isolation time period is determined as a function of the transfer current intensity by means of a piecewise constant function.

7. A device according to claim 3, wherein the isolation time period is determined as a function of the transfer current intensity by an affine function.

8. A device according to claim 1, wherein the acquisition module comprises a sensor for the time derivative of current intensity, configured so as to measure the time derivative of current intensity.

9. A device according to claim 1, wherein the peak current intensity threshold value is lower than 10,000 A.

10. A device according to claim 1 wherein the peak current intensity threshold value is lower than 6,000 A.

11. A device according to claim 1 wherein the peak current intensity threshold value is equal to 4,500 A.

12. A control method for controlling an electrical protection device according to claim 1, the method comprising at least the following steps:
measuring the current intensity by the acquisition module;
determining the time derivative of current intensity by the acquisition module;
determining the first value of the estimated peak current intensity, as a function of the current intensity and of the time derivative of current intensity by the control unit;
if the first value of the estimated peak current intensity is greater than or equal to the peak current intensity threshold value, commanding, by the electronic control unit, the switching of the mechanical switch to the open configuration;
determining the isolation time period or determining the second value of the estimated peak current intensity; and
if the isolation time period has elapsed, or if the second value of the estimated peak current intensity is greater than or equal to the peak current intensity threshold value, commanding, by the electronic control unit, the switching of the static switch to the isolation configuration.

13. A method according to claim 10, wherein the second value of the estimated peak current intensity is determined as a function of a sampling time, and, if the second value of the estimated peak current intensity is strictly lower than the peak current intensity threshold value, the determining of the second value of the estimated peak current intensity is performed again when the sampling time has elapsed.
